(19) United States
(12) Patent Application Publication
(10) Pub. No.: US 2021/0075629 A1
(43) Pub. Date: Mar. 11, 2021

(54) SIGNAL TRANSMISSION SYSTEM

(71) Applicant: SHENZHEN LENKENG TECHNOLOGY CO., LTD, Shenzhen (CN)

(72) Inventor: BINGHAI GAO, Shenzhen (CN)

(21) Appl. No.: 16/944,196

(22) Filed: Jul. 31, 2020

(30) Foreign Application Priority Data
Sep. 6, 2019 (CN) 201921480357.9

(51) Int. Cl. H04L 12/10; H04B 3/50

(52) U.S. Cl. CPC H04L 12/10; H04B 3/50

(57) ABSTRACT

A signal transmission system is provided. The signal transmission system includes a transmitting device and a receiving device. The transmitting device is communicatively connected with the receiving device via cables. The transmitting device includes a first transceiver module, a power supply module, and a first processing module connected with the first transceiver module and the power supply module. The receiving device includes a second transceiver module and a second processing module connected with the second transceiver module. According to the signal transmission system, direct current signal can be transmitted to electric equipment while differential signal is transmitted between the transmitting device and the receiving device by Ethernet cables, on one hand, wiring costs can be reduced, on the other hand, construction time is reduced and user experience is improved.

### CROSS REFERENCE TO RELATED APPLICATIONS

This application claims priority to Chinese Patent Application Serial No. 201921480357.9 on Sep. 6, 2019, the disclosure of which is hereby incorporated by reference.

### TECHNICAL FIELD

The disclosure relates to the field of power supply over Ethernet technologies, and in particular to a signal transmission system.

### BACKGROUND

At present, there are a large number of electric equipment, such as wireless APs, IP phones, network cameras, and extenders. The electric device is generally arranged in special and limit power-supplying place, which may consume a lot of manpower and material resources and greatly increase cost of the wiring, thereby further leading to prolong of construction time.

### SUMMARY

Based on the foregoing problems and disadvantages of the prior art, a signal transmission system is provided. In the signal transmission system, direct current signal is transmitted to electric equipment while transmitting, via Ethernet cables, differential signal to the electric equipment, so that wiring costs can be reduced, construction time can be reduced, and user experience is improved.

According to a first aspect, a signal transmission system is provided. The signal transmission system includes a transmitting device and a receiving device. The transmitting device is communicatively connected with the receiving device via cables. The transmitting device includes a first transceiver module, a power supply module, and a first processing module connected with the first transceiver module and the power supply module. The receiving device includes a second transceiver module and a second processing module connected with the second transceiver module.

According to a second aspect, a transmitting device is provided. The transmitting device includes: a first transceiver module, configured to receive first multimedia signal; a power supply module, configured to output first direct current signal; and a first processing module configured to process at least one of the first multimedia signal and the first direct current signal to obtain first signal.

In some implementations, the first processing module is specifically configured to encode the first multimedia signal to obtain first differential signal, and obtain the first signal by superimposing the first differential signal with the first direct current signal.

In some implementations, the first processing module configured to process at least one of the first multimedia signal and the first direct current signal to obtain the first signal is configured to encode the first multimedia signal to obtain first differential signal, and obtain the first signal by superimposing the first differential signal with the first direct current signal.

In some implementations, the transmitting device further includes: a first network isolation transformer module, configured to isolate the first signal for removing interference signal of the first signal to obtain isolated first signal.

In some implementations, the transmitting device further includes a first network isolation transformer module configured to isolate the first signal for removing interference signal of the first signal to obtain isolated first signal.

In some implementations, the transmitting device further includes a first network isolation transformer module configured to isolate the first signal for removing interference signal of the first signal to obtain isolated first signal, where the isolated first signal includes isolated first direct current signal and isolated first differential signal.

In some implementations, the first transceiver module is further configured to transmit the first signal to the receiving device via a designated twisted pair of a plurality of twisted pairs.

In some implementations, the first transceiver module is further configured to transmit the first signal to the receiving device via a designated twisted pair of a plurality of twisted pairs.

In some implementations, the first transceiver module is further configured to transmit the first direct current signal to the receiving device via a designated twisted pair of a plurality of twisted pairs, and transmit the first differential signal to the receiving device by other twisted pairs in the plurality of twisted pairs other than the designated twisted pair.

In some implementations, the first transceiver module is further configured to transmit the first signal to the receiving device via a designated twisted pair of a plurality of twisted pairs.

In some implementations, the first transceiver module is further configured to transmit the isolated first signal to the receiving device.

In some implementations, the first transceiver module is further configured to transmit the isolated first signal to the receiving device.

In some implementations, the first transceiver module is further configured to transmit the isolated first direct current signal to the receiving device via a designated twisted pair of a plurality of twisted pairs, and transmit the isolated first differential signal to the receiving device by other twisted pairs in the plurality of twisted pairs other than the designated twisted pair.

In some implementations, the first transceiver module is further configured to transmit the isolated first signal to the receiving device via a designated twisted pair of a plurality of twisted pairs.

According to a third aspect of implementations, a receiving device is provided. The receiving device includes a second transceiver module and a second processing module connected with the second transceiver module.

In some implementations, the receiving device is connected with a display; and the receiving device is configured to: receive, by the second transceiver module, from a transmitting device; and process, by the second processing module, the first signal to obtain first specific multimedia signal, and transmit, by the second transceiver module, the first specific multimedia signal to the display configured to display the first specific multimedia signal.

In some implementations, the receiving device is connected with a display; and the receiving device is configured to: receive, by the second transceiver module, first signal from a transmitting device; and process, by the second processing module, the first signal to obtain first specific multimedia signal, and transmit, by the second transceiver module, the first specific multimedia signal to the display configured to display the first specific multimedia signal.

In some implementations, the receiving device is connected with a display, and the receiving device further includes a second network isolation transformer module, where the receiving device is configured to receive, by the second transceiver module, first signal from a transmitting device; isolate, by the second network isolation transformer module, the first signal from the transmitting device for removing interference signal of the first signal to obtain isolated first signal; and process, by the second processing module, the isolated first signal to obtain first specific multimedia signal, and transmit, by the second transceiver module, the first specific multimedia signal to the display configured to display the first specific multimedia signal.

In some implementations, the receiving device is connected with a display, and the receiving device further includes a second network isolation transformer module, where the receiving device is configured to receive, by the second transceiver module, first signal from a transmitting device; isolate, by the second network isolation transformer module, the first signal from the transmitting device for removing interference signal of the first signal to obtain isolated first signal; and process, by the second processing module, the isolated first signal to obtain first specific multimedia signal, and transmit, by the second transceiver module, the first specific multimedia signal to the display configured to display the first specific multimedia signal.

The signal transmission system provided in the implementations includes the transmitting device and the receiving device, where the transmitting device is communicatively connected with the receiving device via cables; the transmitting device includes the first transceiver module, the power supply module, and the first processing module connected with the first transceiver module and the power supply module; the receiving device includes the second transceiver module and the second processing module connected with the second transceiver module. According to the signal transmission system provided in the implementations, the transmitting device transmits the first direct current signal to the receiving device while transmitting the multimedia signal by the twisted pairs, thereby achieving the goal of supplying power to the receiving device. Compared with the prior art, the implementations have the following beneficial effects: direct current signal can be transmitted to electric equipment while the differential signal is transmitted between the transmitting device and the receiving device by Ethernet cables, so that wiring costs can be reduced, construction time can be reduced, and user experience is improved.

### BRIEF DESCRIPTION OF THE DRAWINGS

In order to describe technical solutions in implementations of the disclosure more clearly, the following briefly introduces the accompanying drawings required for describing the implementations. Apparently, the accompanying drawings in the following description show merely some implementations of the disclosure. For ordinary technicians, other accompanying drawings can be obtained based on these accompanying drawings without paying creative work.

FIG. 1 is a schematic diagram illustrating a signal transmission system according to implementations.

FIG. 2 is a schematic diagram illustrating first differential signal according to implementations.

FIG. 3 is a schematic diagram illustrating first direct current signal according to implementations.

FIG. 4 is a schematic diagram illustrating a superimposed signal according to implementations.

FIG. 5 is a schematic diagram illustrating another signal transmission system according to implementations.

FIG. 6 is a schematic diagram illustrating a first network isolation transformer module according to implementations.

FIG. 7 is a schematic diagram illustrating a tap connection of a first network isolation transformer module according to implementations.

FIG. 8 is a schematic diagram illustrating a tap connection of another first network isolation transformer module according to implementations.

FIG. 9 is a schematic diagram illustrating another first network isolation transformer module according to implementations.

FIG. 10 is a schematic diagram illustrating another signal transmission system according to implementations.

FIG. 11 is a schematic diagram illustrating another signal transmission system according to implementations.

### DETAILED DESCRIPTION OF THE PREFERRED IMPLEMENTATIONS

In order to describe technical solutions in implementations more clearly, the following briefly describes accompanying drawings required for describing the implementations. The accompanying drawings in the following description only illustrates some implementations. For ordinary technicians, other accompanying drawings can be obtained based on these accompanying drawings without paying creative work.

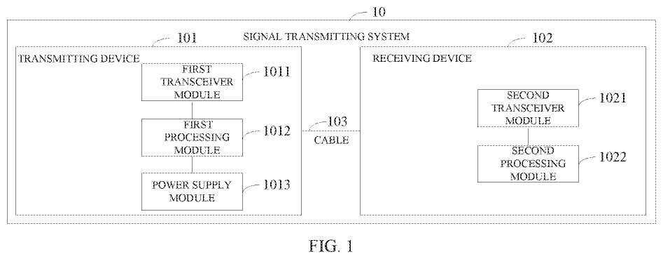

FIG. 1 is a schematic diagram illustrating a signal transmission system according to implementations. As shown in FIG. 1, the signal transmission system 10 can include a transmitting device 101 and a receiving device 102, where the transmitting device 101 is communicatively connected with the receiving device 102 via cables 103. The transmitting device 101 includes a first transceiver module 1011, a power supply module 1013, and a first processing module 1012 connected with the first transceiver module 1011 and the power supply module 1013. The receiving device 102 includes a second transceiver module 1021 and a second processing module 1022 connected with the second transceiver module 1021.

It should be noted that the first transceiver module 1011 can be configured to receive first multimedia signal, where the first multimedia signal can include, but is not limited to, audio signal and video signal.

Specifically, the first transceiver module 1011 is configured to operate as follows: after an high definition multimedia interface (HDMI) signal inputted by a source device connected with the transmitting device 101 is received, where first multimedia signal is obtained by decoding the HDMI signal by the transmitting device 101.

The power supply module 1013 can be configured to output first direct current signal, where the first direct current signal can include: direct current signal whose magnitude and direction do not change with time.

The first processing module 1012 is configured to process at least one of the first multimedia signal and the first direct current signal to obtain first signal.

It should be noted that the first processing module 1012 can be configured to operate as follows.

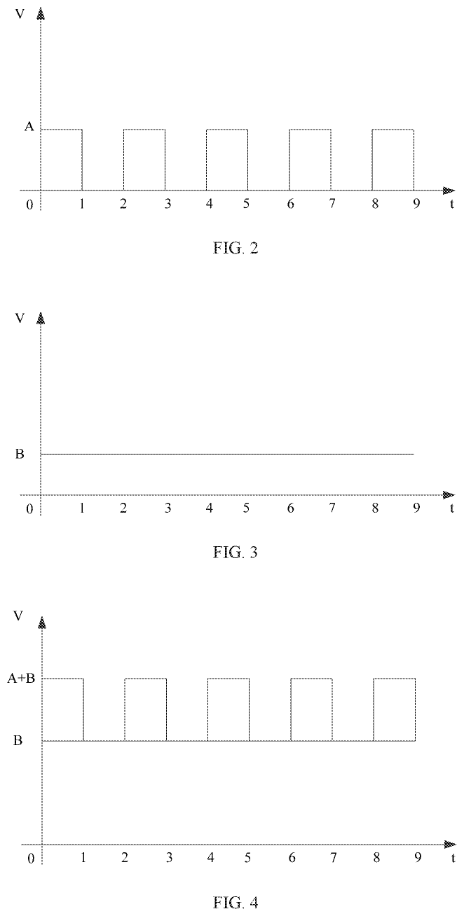

First aspect: the first processing module 1012 configured to process at least one of the first multimedia signal and the first direct current signal to obtain the first signal is configured to: encode the first multimedia signal to obtain first differential signal, and obtain the first signal by superimposing the first differential signal with the first direct current signal. The following describes, with reference to FIG. 2 to FIG. 4, how to obtain the first signal by superimposing the first differential signal with the first direct current signal.

FIG. 2 is a schematic diagram illustrating first differential signal according to implementations. As shown in FIG. 2, the voltage (V) of the first differential signal changes with time t, where A is a constant, the vertical axis represents the voltage (V) of the direct current signal, and the horizontal axis represents time (t).

FIG. 3 is a schematic diagram illustrating first direct current signal according to implementations. As shown in FIG. 3, the voltage (V) of the first direct current signal does not change with time t, where B is a constant, the vertical axis represents the voltage (V) of the direct current signal, and the horizontal axis represents time (t).

FIG. 4 is a schematic diagram illustrating a superimposed signal. As shown in FIG. 4, the superimposed signal shown in the figure is a superimposed signal obtained by superimposing the first differential signal shown in FIG. 2 with the first direct current signal shown in FIG. 3, where A and B are constants, the vertical axis represents the voltage (V) of the direct current signal, and the horizontal axis represents time (t).

It should be noted that the first differential signal can include, but is not limited to, transition-minimized differential signaling (TMDS), an internet protocol (IP) datagram or a user datagram protocol (UDP) packet, or the like.

Second aspect: The first processing module 1012 can be configured to process at least one of the first multimedia signal and the first direct current signal to obtain the first signal is configured to: encode the first multimedia signal to obtain first differential signal, and obtain the first signal including the first differential signal and the first direct current signal based on the first direct current signal inputted to the first processing module 1012, where the first differential signal and the first direct current signal are not superimposed.

It should be noted that the cables 103 can include a plurality of twisted pairs, and preferably, the cables 103 include four twisted pairs.

Taking the plurality of twisted pairs as four twisted pairs as an example, the transmitting device 101 can transmit the first signal to the receiving device 102 by twisted pairs, and transmitting, by the transmitting device 101, the first signal to the receiving device 102 via twisted pairs can be explained from the following two aspects.

First aspect: The transmitting device 101 can be specifically configured to transmit, before the first differential signal and the first direct current signal are superimposed, the first direct current signal to the receiving device 102 via a designated twisted pair among the four twisted pairs, and transmit the first differential signal to the receiving device 102 by a twisted pair other than the forgoing designated twisted pair among the four twisted pairs.

Second aspect: The transmitting device 101 can be specifically configured to transmit the first signal to the receiving device 102 via a designated twisted pair among the four twisted pairs.

In summary, in the implementations, the first direct current signal from the transmitting device is transmitted, via the twisted pairs, to the receiving device 102 while the multimedia signal from the transmitting device is transmitted to the receiving device 102 via the twisted pairs, thereby achieving the goal of supplying power to the receiving device 102.

It should be noted that the receiving device 102 is connected with a display, where the display can be configured to display multimedia signal.

It should be noted that the receiving device 102 can be configured to: receive, by the second transceiver module 1021, the first signal from the transmitting device 101; and separate, by the second processing module 1022, the first signal to obtain a first specific differential signal and first direct current signal, then decode the first specific differential signal to obtain first specific multimedia signal, and transmit, by the second transceiver module 1021, the first specific multimedia signal to the display configured to display the first specific multimedia signal.

It should be noted that the second transceiver module 1021 can be further configured to receive a first infrared control signal. Specifically, the second transceiver module 1021 configured to receive a first infrared control signal is configured to receive the first infrared control signal transmitted by a remote control 1 by an infrared receiving head of the receiving device 102.

The second processing module 1022 can be further configured to obtain a second signal by superimposing the first specific differential signal with the first infrared control signal: and the second transceiver module 1021 can be further configured to transmit the second signal to the transmitting device 101.

Taking a plurality of pairs of cables being four twisted pairs as an example, a joint working process of the second transceiver module 1021 and the twisted pairs can be described.

The second transceiver module 1021 can be further configured to transmit the second signal to the transmitting device 101 via a designated twisted pair (for example, A1) among four twisted pairs (the names of the twisted pairs can be A1, A2, A3, and A4 respectively).

It should be noted that the transmitting device 101 is connected with a source device; the transmitting device 101 can be further configured to: receive, by the first transceiver module 1011, a second signal from the receiving device 102; and separate, by the first processing module 1012, the second signal to obtain a first specific infrared control signal, where the first specific infrared control signal is used to control the source device connected with the transmitting device 101.

It should be noted that using the twisted pairs to transmit the first signal can reduce or eliminate common-mode interference of cables configured to transmit the signal.

It should be noted that the first transceiver module 1011 can be further configured to receive, by an infrared receiving head of the transmitting device 101, the second infrared control signal transmitted by the remote control 2.

It should be noted that among four twisted pairs (D1, D2, D3, and D4), in addition to one twisted pair (D1) configured to transmit the second signal, the other three twisted pairs (D2, D3, and D4) can be respectively configured to transmit: signal which is obtained by superimposing the second infrared control signal with the first differential signal, signal which is obtained by superimposing ground signal and the first differential signal, and signal which is obtained by superimposing the second infrared control signal with the second differential signal.

FIG. 2 to FIG. 4 are merely used to describe the implementations and should not limit the implementations.

As can be seen, the signal transmission system is provided. The signal transmission system includes the transmitting device 101 and the receiving device 102, where the transmitting device 101 is communicatively connected with the receiving device 102 via cables 103; and the transmitting device 101 includes the first transceiver module 1011, the first processing module 1012 and the power supply module 1013. multimedia signal received by the first transceiver module 1011 is encoded by the first processing module 1012 to obtain first differential signal, and then first direct current signal being outputted by the power supply module 1013 is superimposed with the first differential signal by the first processing module 1012, and the superimposed signal is transmitted to the receiving device 102 by the first transceiver module 1011 via combining the twisted pairs, so that the first direct current signal is transmitted to the receiving device 102 while the multimedia signal is transmitted to the receiving device 102, thereby achieving the goal of supplying power to the receiving device 102. Compared with the prior art, the implementations have the following beneficial effects: direct current signal from the transmitting device further can be transmitted to electric equipment connected with the receiving device while differential signal from the transmitting device is transmitted to the receiving device between the transmitting device and the receiving device via Ethernet cables, so that wiring costs can be reduced, construction time can be reduced, and user experience is improved.

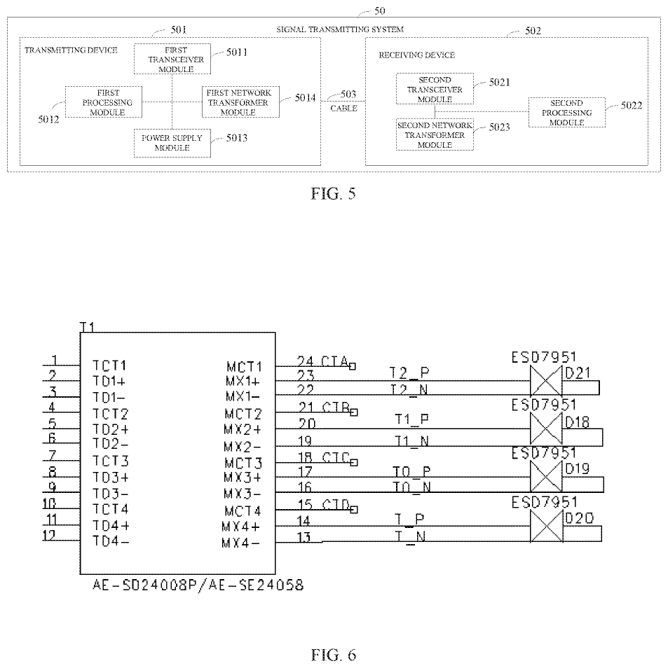

FIG. 5 is a schematic diagram illustrating a signal transmission system according to implementations. It should be noted that for definitions and related explanations not set forth in FIG. 5, refer to the implementation shown in FIG. 1.

As shown in FIG. 5, the signal transmission system 50 can include a transmitting device 501 and a receiving device 502. The transmitting device 501 is communicatively connected with the receiving device 502 via cables 503. The transmitting device 501 includes a first transceiver module 5011, a first processing module 5012, a power supply module 5013, and a first network isolation transformer module 5014, where first processing module 5012, the first transceiver module 5011, the power supply module 5013, and the first network isolation transformer module 5014 are connected with each other.

The receiving device 502 includes a second transceiver module 5021, a second processing module 5022 and a second network isolation transformer module 5023, where the second transceiver module 5021, the second processing module 5022 and the second network isolation transformer module 5023 are connected with each other.

It should be noted that the first transceiver module 5011 can be configured to receive first multimedia signal inputted by a video source device connected with the transmitting device 501, where the first multimedia signal can include, but is not limited to, audio signal and video signal.

The power supply module 5013 can be configured to output first direct current signal, where the first direct current signal can include: direct current signal whose magnitude and direction do not change with time.

The first processing module 5012 is configured to process at least one of the first multimedia signal and the first direct current signal to obtain first signal.

It should be noted that the first processing module 5012 can be specifically used in at least the following aspects:

First aspect: The first processing module 5012 can be configured to encode the first multimedia signal to obtain first differential signal, and obtain the first signal by superimposing the first differential signal with the first direct current signal.

It should be noted that the first differential signal can include, but is not limited to, TMDS, an IP datagram or a UDP packet, or the like.

Second aspect: The first processing module 5012 can be specifically configured to encode the first multimedia signal to obtain first differential signal, and obtain the first signal including the first differential signal and the first direct current signal based on the first direct current signal input to the first processing module 5012, where the first differential signal and the first direct current signal are not superimposed.

It should be noted that the first network isolation transformer module 5014 is configured to isolate the first signal processed by the first processing module 5012 for removing interference signal of the first signal to obtain isolated first signal. It should be noted that the first network isolation transformer module 5014 can include, but is not limited to, a network isolation transformer.

It can be understood that the first network isolation transformer module 5014 may be mainly configured to remove interference signal of the first signal to obtain isolated first signal with greater signal strength. In addition, the first network isolation transformer module 5014 can isolate an internal module of the transmitting device 501 from the external of the transmitting device 501 for protection. For example, when the transmitting device 501 is struck by lightning, the network isolation transformer module 5014 protects the internal module of the transmitting device 501 (a specific reason is that a center tap of the network isolation transformer module 5014 is grounded to drain energy generated by the lightning to the ground).

FIG. 6 is a schematic diagram illustrating a first network isolation transformer module according to implementations.

As shown in FIG. 6, T1 refers to a first network transformer module. It should be noted that the first network transformer module T1 is provided with four taps including CTA, CTB, CTC, CTD, and eight pins that can be configured to connect four twisted pairs.

FIG. 7 is a schematic diagram illustrating a tap connection of a first network isolation transformer module according to implementations.

As shown in FIG. 7, the first network isolation transformer module is included in the transmitting device 501, and one end of each tap (CTA, CTB, CTC and CTD) of the first network isolation transformer module performs grounding operations after the end of each tap (CTA, CTB, CTC and CTD) of the first network isolation transformer module is respectively connected with inductors L, capacitors C or other devices, thereby realizing the protection effect of the first network isolation transformer module on the internal module of the transmitting device 501. For example, when the transmitting device 501 is encountered with a lightning strike, since the center tap CTA of the first network isolation transformer module is grounded, the transmitting device 501 can drain the energy generated by the lightning strike to the ground by the center tap CTA of the second network isolation transformer module. It should be noted that the second network isolation transformer module further includes a transient voltage suppressor (TVS) tube, and residual energy can be discharged by diodes of the TVS tube.

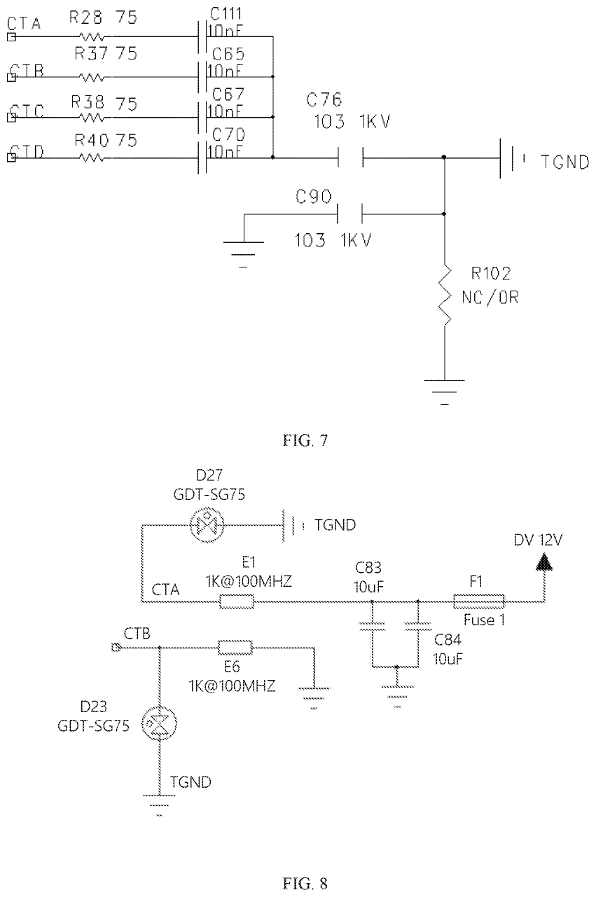

FIG. 8 is a schematic diagram illustrating a tap connection of another first network isolation transformer module according to implementations.

As shown in FIG. 8, the first network isolation transformer module is connected with a power supply circuit by the other end of the tap CTA, so that first direct current signal outputted by the power supply circuit can be inputted to the first network isolation transformer module.

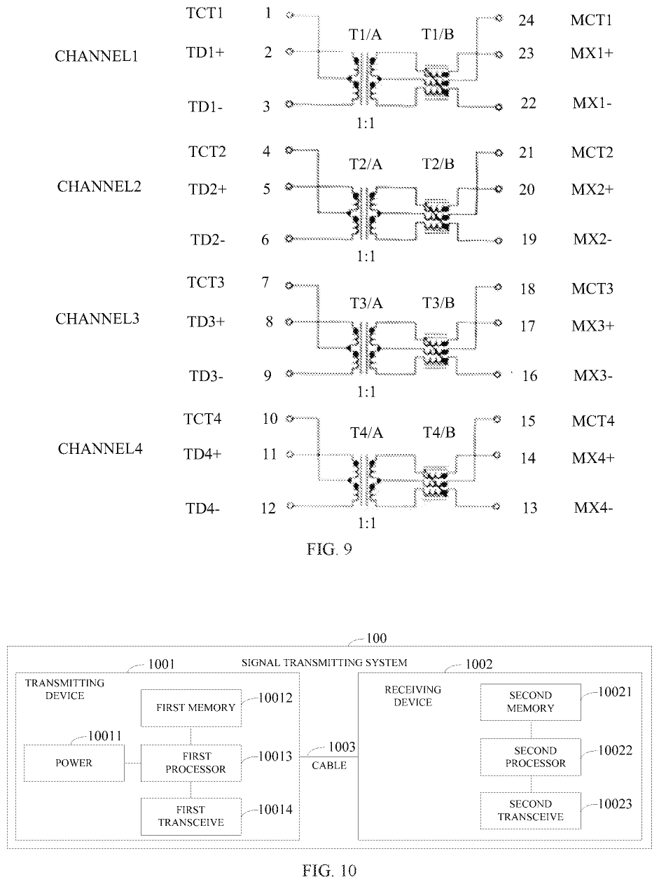

FIG. 9 is a schematic diagram illustrating another first network isolation transformer module according to implementations.

As shown in FIG. 9, the first network isolation transformer module can be disposed in the transmitting device 501 according to implementations. The first network isolation transformer module can include a plurality of coils respectively wound with magnetic materials (such as T/A, T1/B, T2/A, T2/B, T3/A, T3/B, T4/A, and T4/B).

It should be noted that the first network isolation transformer module is equipped with pins such as MX1+, MX1−, MX2+, MX2−, MX3+, MX3−, MX4+ and MX4−, which can be configured to connect four twisted pairs for transmission of first signal.

It should be noted that the first network isolation transformer module is equipped with pins such as MCT1, MCT2, MCT3, and MCT4, which can be used for grounding to protect internal modules of the transmitting device 501.

It should be noted that the cables 503 can include a plurality of twisted pairs, and preferably, the cables 503 include four twisted pairs.

Taking a plurality of twisted pairs being four twisted pairs as an example, a joint working process of the first transceiver module 5011 and the twisted pairs can be described from the following two aspects.

First aspect: The first transceiver module 5011 is further specifically configured to transmit, before the first differential signal and the first direct current signal are superimposed, the first direct current signal to the receiving device 502 via a designated twisted pair among the four twisted pairs, and transmit the first differential signal to the receiving device 502 by a twisted pair other than the forgoing designated twisted pair among the four twisted pairs.

Second aspect: The first transceiver module 5011 may be further specifically configured to transmit the first signal to the foregoing receiving device 502 via a designated twisted pair among the foregoing four twisted pairs.

In summary, in the implementations, the first direct current signal is transmitted to the receiving device 502 while the multimedia signal is transmitted to the receiving device 502 by the twisted pairs, thereby achieving the goal of supplying power to the receiving device 502.

It should be noted that the receiving device 502 is connected with a display, where the display can be configured to display multimedia signal.

It should be noted that the receiving device 502 can be specifically configured to: receive, by the second transceiver module 5021, the first signal from the transmitting device 501: isolate, by the second network isolation transformer module 5023, the first signal for removing interference signal of the received first signal to obtain isolated first signal; and separate, by the second processing module 5022, the isolated first signal to obtain first specific differential signal and first direct current signal, then decode the first specific differential signal to obtain first specific multimedia signal, and transmit, by the second transceiver module 5021, the first specific multimedia signal to the display configured to display the first specific multimedia signal.

It should be noted that the structure and connection relationship of the second network isolation transformer module 5023 can be seen in FIG. 6, FIG. 7 and FIG. 8.

It should be noted that the second network isolation transformer module 5023 can include, but is not limited to, a network isolation transformer. It can be understood that the second network isolation transformer module 5023 can be mainly configured to enhance the strength of the first signal received by the receiving device 502. In addition, the second network isolation transformer module 5023 can isolate the internal module of the receiving device 502 from the external of the receiving device 502 for protection. For example, when the receiving device 502 is encountered with a lightning strike, since the center tap CTA of the second network isolation transformer module 5023 is grounded, the receiving device 502 can drain the energy generated by the lightning strike to the ground by the center tap CTA of the second network isolation transformer module 5023. It should be noted that the second network isolation transformer module 5023 further includes a TVS tube, and residual energy can be discharged by diodes of the TVS tube.

It should be noted that the second transceiver module 5021 can be further configured to receive a first infrared control signal; the second processing module 5022 is configured to separate the first signal received by the second transceiver module 5021 to obtain a first specific differential signal and first direct current signal; the second processing module 5022 can be further configured to obtain second signal by superimposing the first specific differential signal with the first infrared control signal; the second transceiver module 5021 can be further configured to transmit the second signal to the transmitting device 501.

Taking a plurality of pairs of cables being four twisted pairs as an example, a joint working process of the second transceiver module 5021 and the twisted pairs can be described.

The second transceiver module 5021 can be further configured to transmit the second signal to the transmitting device 501 via a designated twisted pair among four twisted pairs.

It should be noted that the transmitting device 501 is connected with a source device; and the transmitting device 501 can be specifically configured to: receive, by the first transceiver module 5011, second signal from the receiving device 502; isolate, by the first network isolation transformer module 5014, the second signal for removing interference signal of the received second signal to obtain isolated second signal; separate, by the first processing module 5012, the isolated second signal to obtain first specific infrared control signal, where the first specific infrared control signal is used to control the source device connected with the transmitting device 501.

FIG. 6 to FIG. 9 are merely used to describe the implementations and should not limit the implementations.

In summary, in the implementations, multimedia signal received by the first transceiver module 5011 is encoded by the first processing module 5012 to obtain the first differential signal, and then the first direct current signal outputted by the power supply module 5013 is superimposed with the foregoing first differential signal by the first processing module 5012, the superimposed signal is processed by the first network isolation transformer module 5014, and the signal processed by the first network isolation transformer module 5014 is transmitted, by the first transceiver module 5011, to the receiving device 502 by combining twisted pairs. The first direct current signal is transmitted to the receiving device 502 while the multimedia signal is transmitted to the receiving device 502, thereby achieving the goal of supplying power to the receiving device 502. Compared with the prior art, the implementations have the following beneficial effects: the direct current signal can be transmitted to electric equipment while the differential signal is transmitted between the transmitting device and the receiving device by Ethernet cables, so that wiring costs can be reduced, construction time can be reduced, and user experience is improved.

FIG. 10 is a schematic diagram illustrating a signal transmission system according to implementations. As shown in FIG. 10, the signal transmission system 100 can include a transmitting device 1001 and a receiving device 1002, where the transmitting device 1001 is communicatively connected with the receiving device 1002 via cables 1003. The transmitting device 1001 includes a power 10011, a first memory 10012, a first transceiver 10014, and a first processor 10013 connected with the first transceiver module 10014, the first memory 10012, and the power 10010 respectively. The receiving device 102 includes a second memory 10021, a second transceiver 10023, and a second processing module 1022 connected with the second transceiver module 10023 and the second memory 10021 respectively.

It should be noted that the first transceiver 10014 can be configured to receive first multimedia signal, where the first multimedia signal can include, but is not limited to, audio signal and video signal.

Specifically, the first transceiver 10014 is configured to operate as follows: after an HDMI signal inputted by a source device connected with the transmitting device 1001 is received, where first multimedia signal is obtained by decoding the HDMI signal by the transmitting device 1001.

The first memory 10012 can be configured to store the first multimedia signal.

The power 10013 can be configured to output first direct current signal, where the first direct current signal can include: direct current signal whose magnitude and direction do not change with time.

The first processor 10013 is configured to process at least one of the first multimedia signal and the first direct current signal to obtain first signal.

It should be noted that the first processor 10013 can be configured to operate as follows.

First aspect: the first processor 10013 configured to process at least one of the first multimedia signal and the first direct current signal to obtain the first signal is configured to: encode the first multimedia signal to obtain first differential signal, and obtain the first signal by superimposing the first differential signal with the first direct current signal.

t should be noted that how to obtain the first signal by superimposing the first differential signal with the first direct current signal with reference to FIG. 2 to FIG. 4.

It should be noted that the first differential signal can include, but is not limited to, TMDS, an IP datagram or a UDP packet, or the like.

Second aspect: The first processor 10013 can be configured to process at least one of the first multimedia signal and the first direct current signal to obtain the first signal is configured to: encode the first multimedia signal to obtain first differential signal, and obtain the first signal including the first differential signal and the first direct current signal based on the first direct current signal inputted to the first processor 10013, where the first differential signal and the first direct current signal are not superimposed.

It should be noted that the cables 1003 can include a plurality of twisted pairs, and preferably, the cables 1003 include four twisted pairs.

Taking the plurality of twisted pairs as four twisted pairs as an example, the transmitting device 1001 can transmit the first signal to the receiving device 1002 by twisted pairs, and transmitting, by the transmitting device 1001, the first signal to the receiving device 1002 via twisted pairs can be explained from the following two aspects.

First aspect: The transmitting device 1001 can be specifically configured to transmit, before the first differential signal and the first direct current signal are superimposed, the first direct current signal to the receiving device 1002 via a designated twisted pair among the four twisted pairs, and transmit the first differential signal to the receiving device 1002 by a twisted pair other than the forgoing designated twisted pair among the four twisted pairs.

Second aspect: The transmitting device 1001 can be specifically configured to transmit the first signal to the receiving device 1002 via a designated twisted pair among the four twisted pairs.

In summary, in the implementations, the first direct current signal from the transmitting device is transmitted, via the twisted pairs, to the receiving device 1002 while the multimedia signal from the transmitting device is transmitted to the receiving device 1002 via the twisted pairs, thereby achieving the goal of supplying power to the receiving device 1002.

It should be noted that the receiving device 1002 is connected with a display, where the display can be configured to display multimedia signal.

It should be noted that the receiving device 1002 can be configured to: receive, by the second transceiver 10023, the first signal, where the first signal is received from the transmitting device 1001, store, by the second memory 10021, the first signal; separate, by the second processor 10022, the first signal to obtain a first specific differential signal and first direct current signal, then decode the first specific differential signal to obtain first specific multimedia signal, and transmit, by the second transceiver 10023, the first specific multimedia signal to the display configured to display the first specific multimedia signal.

It should be noted that the second transceiver 10023 can be further configured to receive a first infrared control signal. Specifically, the second transceiver 10023 configured to receive a first infrared control signal is configured to receive the first infrared control signal transmitted by a remote control 1 by an infrared receiving head of the receiving device 1002.

The second processor 10022 can be further configured to obtain a second signal by superimposing the first specific differential signal with the first infrared control signal; and the second transceiver 10023 can be further configured to transmit the second signal to the transmitting device 1001.

Taking a plurality of pairs of cables being four twisted pairs as an example, a joint working process of the second transceiver 10023 and the twisted pairs can be described.

The second transceiver 10023 can be further configured to transmit the second signal to the transmitting device 1001 via a designated twisted pair (for example, A1) among four twisted pairs (the names of the twisted pairs can be A1, A2, A3, and A4 respectively).

It should be noted that the transmitting device 1001 is connected with a source device; the transmitting device 1001 can be further configured to: receive, by the first transceiver 10014, second signal from the receiving device 1002; and separate, by the first processor 10013, the second signal to obtain a first specific infrared control signal, where the first specific infrared control signal is used to control the source device connected with the transmitting device 1001.

It should be noted that using the twisted pairs to transmit the first signal can reduce or eliminate common-mode interference of cables configured to transmit the signal.

It should be noted that the first transceiver 10014 can be further configured to receive, by an infrared receiving head of the transmitting device 101, the second infrared control signal transmitted by the remote control 2.

It should be noted that among four twisted pairs (D1, D2, D3, and D4), in addition to one twisted pair (D1) configured to transmit the second signal, the other three twisted pairs (D2, D3, and D4) can be respectively configured to transmit: signal which is obtained by superimposing the second infrared control signal with the first differential signal, signal which is obtained by superimposing ground signal and the first differential signal, and signal which is obtained by superimposing the second infrared control signal with the second differential signal.

As can be seen, the signal transmission system is provided. The signal transmission system includes the transmitting device 1001 and the receiving device 1002, where the transmitting device 1001 is communicatively connected with the receiving device 1002 via cables 1003; and the transmitting device 1001 includes the first transceiver0 10014, the first processor 10013 and the power 10011. multimedia signal received by the first transceiver 10014 is encoded by the first processor 10013 to obtain first differential signal, and then first direct current signal being outputted by the power 10011 is superimposed with the first differential signal by the first processor 10013, and the superimposed signal is transmitted to the receiving device 1002 by the first transceiver 10014 via combining the twisted pairs, so that the first direct current signal is transmitted to the receiving device 1002 while the multimedia signal is transmitted to the receiving device 1002, thereby achieving the goal of supplying power to the receiving device 1002. Compared with the prior art, the implementations have the following beneficial effects: direct current signal from the transmitting device further can be transmitted to electric equipment connected with the receiving device while differential signal from the transmitting device is transmitted to the receiving device between the transmitting device and the receiving device via Ethernet cables, so that wiring costs can be reduced, construction time can be reduced, and user experience is improved.

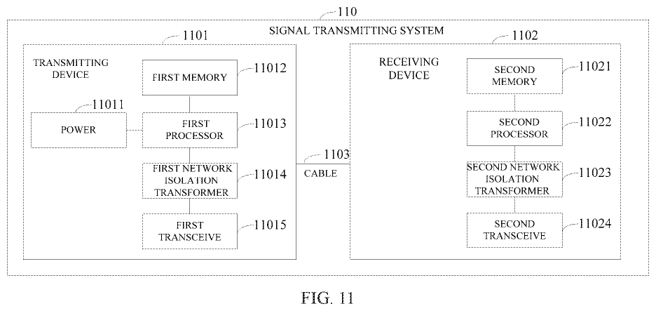

FIG. 11 is a schematic diagram illustrating a signal transmission system according to implementations. It should be noted that for definitions and related explanations not set forth in FIG. 11, refer to the implementation shown in FIG. 10.

As shown in FIG. 11, the signal transmission system 110 can include a transmitting device 1101 and a receiving device 1102. The transmitting device 1101 is communicatively connected with the receiving device 1102 via cables 1103. The transmitting device 1101 includes a first transceiver 11015, a first processor 11013, a power 11011, a first memory 11012 and a first network isolation transformer 11014, where first processing module 11013, the first memory 11012, the first transceiver 11015, the power 11011, and the first network isolation transformer 11014 are connected with each other.

The receiving device 1102 includes a second transceiver 11024, a second processor 11022, a second memory 11021 and a second network isolation transformer 11023, where the second transceiver 11024, the second processor 11022, the second memory 11021 and the second network isolation transformer 11023 are connected with each other.

It should be noted that the first transceiver 11015 can be configured to receive first multimedia signal input by a video source device connected with the transmitting device 1101, where the first multimedia signal can include, but is not limited to, audio signal and video signal.

The first memory 10012 can be configured to first multimedia signal.

The power 11011 can be configured to output first direct current signal, where the first direct current signal can include: direct current signal whose magnitude and direction do not change with time.

The first processor 11013 is configured to process at least one of the first multimedia signal and the first direct current signal to obtain first signal.

It should be noted that the first processor 11013 can be specifically used in at least the following aspects:

First aspect: The first processor 11013 can be configured to encode the first multimedia signal to obtain first differential signal, and obtain the first signal by superimposing the first differential signal with the first direct current signal.

It should be noted that the first differential signal can include, but is not limited to, TMDS, an IP datagram or a UDP packet, or the like.

Second aspect: The first processor 11013 can be specifically configured to encode the first multimedia signal to obtain first differential signal, and obtain the first signal including the first differential signal and the first direct current signal based on the first direct current signal input to the first processor 11013, where the first differential signal and the first direct current signal are not superimposed.

It should be noted that the first network isolation transformer 11014 is configured to isolate the first signal processed by the first processor 11013 for removing interference signal of the first signal to obtain isolated first signal. It should be noted that the first network isolation transformer 11014 can include, but is not limited to, a network isolation transformer.

It can be understood that the first network isolation transformer 11014 may be mainly configured to remove interference signal of the first signal to obtain isolated first signal with greater signal strength. In addition, the first network isolation transformer 11014 can isolate an internal module of the transmitting device 1101 from the external of the transmitting device 1101 for protection. For example, when the transmitting device 1101 is struck by lightning, the network isolation transformer 11014 protects the internal module of the transmitting device 1101 (a specific reason is that a center tap of the network isolation transformer 11014 is grounded to drain energy generated by the lightning to the ground).

It should be noted that a schematic diagram of a first network isolation transformer refers to FIG. 6, FIG. 8 and FIG. 9.

a schematic diagram of a tap connection of a first network isolation transformer refers to FIG. 7.

It should be noted that the cables 1103 can include a plurality of twisted pairs, and preferably, the cables 1103 include four twisted pairs.

Taking a plurality of twisted pairs being four twisted pairs as an example, a joint working process of the first transceiver 11015 and the twisted pairs can be described from the following two aspects.

First aspect: The first transceiver 11015 is further specifically configured to transmit, before the first differential signal and the first direct current signal are superimposed, the first direct current signal to the receiving device 1102 via a designated twisted pair among the four twisted pairs, and transmit the first differential signal to the receiving device 1102 by a twisted pair other than the forgoing designated twisted pair among the four twisted pairs.

Second aspect: The first transceiver 11015 may be further specifically configured to transmit the first signal to the foregoing receiving device 1102 via a designated twisted pair among the foregoing four twisted pairs.

In summary, in the implementations, the first direct current signal is transmitted to the receiving device 1102 while the multimedia signal is transmitted to the receiving device 1102 by the twisted pairs, thereby achieving the goal of supplying power to the receiving device 1102.

It should be noted that the receiving device 1102 is connected with a display, where the display can be configured to display multimedia signal.

It should be noted that the receiving device 1102 can be specifically configured to: receive, by the second transceiver 11024, the first signal from the transmitting device 1101; isolate, by the second network isolation transformer 11023, the first signal for removing interference signal of the received first signal to obtain isolated first signal, and separate, by the second processor 11022, the isolated first signal to obtain first specific differential signal and first direct current signal, then decode the first specific differential signal to obtain first specific multimedia signal, and transmit, by the second transceiver 11024, the first specific multimedia signal to the display configured to display the first specific multimedia signal.

It should be noted that the structure and connection relationship of the second network isolation transformer 11023 can be seen in FIG. 6, FIG. 7, FIG. 8, and FIG. 9.

It should be noted that the second network isolation transformer 11023 can include, but is not limited to, a network isolation transformer. It can be understood that the second network isolation transformer 11023 can be mainly configured to enhance the strength of the first signal received by the receiving device 1102. In addition, the second network isolation transformer 11023 can isolate the internal module of the receiving device 1102 from the external of the receiving device 1102 for protection. For example, when the receiving device 1102 is encountered with a lightning strike, since the center tap CTA of the second network isolation transformer 11023 is grounded, the receiving device 1102 can drain the energy generated by the lightning strike to the ground by the center tap CTA of the second network isolation transformer 11023. It should be noted that the second network isolation transformer 11023 further includes a TVS tube, and residual energy can be discharged by diodes of the TVS tube.

It should be noted that the second transceiver 11024 can be further configured to receive a first infrared control signal; the second processor 11022 is configured to separate the first signal received by the second transceiver 11024 to obtain a first specific differential signal and first direct current signal; the second processor 11022 can be further configured to obtain second signal by superimposing the first specific differential signal with the first infrared control signal; the second transceiver 11024 can be further configured to transmit the second signal to the transmitting device 1101.

Taking a plurality of pairs of cables being four twisted pairs as an example, a joint working process of the second transceiver 11024 and the twisted pairs can be described.

The second transceiver 11024 can be further configured to transmit the second signal to the transmitting device 501 via a designated twisted pair among four twisted pairs.

It should be noted that the transmitting device 1101 is connected with a source device; and the transmitting device 1101 can be specifically configured to: receive, by the first transceiver 11011, second signal from the receiving device 1102; isolate, by the first network isolation transformer 11015, the second signal for removing interference signal of the received second signal to obtain isolated second signal; separate, by the first processor 11013, the isolated second signal to obtain first specific infrared control signal, where the first specific infrared control signal is used to control the source device connected with the transmitting device 1101.

In summary, in the implementations, the multimedia signal received by the first transceiver 11013 is encoded by the first processor 11013 to obtain the first differential signal, and then the first direct current signal outputted by the power 11011 is superimposed with the foregoing first differential signal by the first processor 11013, the superimposed signal is processed by the first network isolation transformer 11014, and the signal processed by the first network isolation transformer 11014 is transmitted, by the first transceiver 11015, to the receiving device 1102 by combining the twisted pairs. The first direct current signal is transmitted to the receiving device 1102 while the multimedia signal is transmitted to the receiving device 1102, thereby achieving the goal of supplying power to the receiving device 1102. Compared with the prior art, the implementations have the following beneficial effects: the direct current signal can be transmitted to electric equipment while the differential signal is transmitted between the transmitting device and the receiving device by Ethernet cables, so that wiring costs can be reduced, construction time can be reduced, and user experience is improved.

1. A signal transmission system, comprising:
a transmitting device comprising: a first transceiver module, a power supply module, and a first processing module connected with the first transceiver module and the power supply module; and
a receiving device communicatively connected with the transmitting device via cables which comprise a plurality of twisted pairs and comprising:
a second transceiver module and a second processing module connected with the second transceiver module.

2. A transmitting device, comprising:
a first transceiver module configured to receive first multimedia signal;
a power supply module configured to output first direct current signal; and
a first processing module configured to process at least one of the first multimedia signal and the first direct current signal to obtain first signal.

3. The transmitting device of claim 2, wherein the first processing module configured to process at least one of the first multimedia signal and the first direct current signal to obtain the first signal is configured to:
encode the first multimedia signal to obtain first differential signal, and
obtain the first signal by superimposing the first differential signal with the first direct current signal.

4. The transmitting device of claim 2, wherein the first processing module configured to process at least one of the first multimedia signal and the first direct current signal to obtain the first signal is configured to:
encode the first multimedia signal to obtain first differential signal; and
obtain the first signal comprising the first differential signal and the first direct current signal based on the first direct current signal, wherein the first differential signal and the first direct current signal are not superimposed.

5. The transmitting device of claim 2, wherein the transmitting device further comprises: a first network isolation transformer module configured to:
isolate the first signal for removing interference signal of the first signal to obtain isolated first signal.

6. The transmitting device of claim 3, wherein the transmitting device further comprises: a first network isolation transformer module configured to:
isolate the first signal for removing interference signal of the first signal to obtain isolated first signal.

7. The transmitting device of claim 4, wherein the transmitting device further comprises: a first network isolation transformer module configured to:
isolate the first signal for removing interference signal of the first signal to obtain isolated first signal, wherein the isolated first signal comprises isolated first direct current signal and isolated first differential signal.

8. The transmitting device of claim 2, wherein the first transceiver module is further configured to: transmit the first signal to the receiving device via a designated twisted pair of a plurality of twisted pairs.

9. The transmitting device of claim 3 wherein the first transceiver module is further configured to: transmit the first signal to the receiving device via a designated twisted pair of a plurality of twisted pairs.

10. The transmitting device of claim 4, wherein the first transceiver module is further configured to: transmit the first direct current signal to the receiving device via a designated twisted pair of a plurality of twisted pairs, and transmit the first differential signal to the receiving device by other twisted pairs in the plurality of twisted pairs other than the designated twisted pair.

11. The transmitting device of claim 4, wherein the first transceiver module is further configured to: transmit the first signal to the receiving device via a designated twisted pair of a plurality of twisted pairs.

12. The transmitting device of claim 5, wherein the first transceiver module is further configured to:
transmit the isolated first signal to the receiving device.

13. The transmitting device of claim 6, wherein the first transceiver module is further configured to:
transmit the isolated first signal to the receiving device.

14. The transmitting device of claim 7, wherein the first transceiver module is further configured to:
transmit the isolated first direct current signal to the receiving device via a designated twisted pair of a plurality of twisted pairs; and
transmit the isolated first differential signal to the receiving device by other twisted pairs in the plurality of twisted pairs other than the designated twisted pair.

15. The transmitting device of claim 7, wherein the first transceiver module is further configured to:
transmit the isolated first signal to the receiving device via a designated twisted pair of a plurality of twisted pairs.

16. A receiving device, comprising: a second transceiver module and a second processing module connected with the second transceiver module.

17. The receiving device of claim 16, wherein the receiving device is connected with a display, and the receiving device is configured to:
receive, by the second transceiver module, first signal from a transmitting device; process, by the second processing module, the first signal to obtain first specific multimedia signal; and
transmit, by the second transceiver module, the first specific multimedia signal to the display configured to display the first specific multimedia signal.

18. The receiving device of claim 16, wherein the receiving device is connected with a display, and the receiving device is configured to:
receive, by the second transceiver module, first signal from a transmitting device;
process, by the second processing module, the first signal to obtain first specific multimedia signal; and
transmit, by the second transceiver module, the first specific multimedia signal to the display configured to display the first specific multimedia signal.

19. The receiving device of claim 16, wherein the receiving device is connected with a display, and the receiving device further comprises a second network isolation transformer module, wherein the receiving device is configured to:
receive, by the second transceiver module, first signal from a transmitting device;
isolate, by the second network isolation transformer module, e for removing interference signal of the first signal to obtain isolated first signal; process, by the second processing module, the isolated first signal to obtain first specific multimedia signal; and
transmit, by the second transceiver module, the first specific multimedia signal to the display configured to display the first specific multimedia signal.

20. The receiving device of claim 16, wherein the receiving device is connected with a display, and the receiving device further comprises a second network isolation transformer module, wherein the receiving device is configured to:
receive, by the second transceiver module, first signal from a transmitting device;
isolate, by the second network isolation transformer module, the first signal from the transmitting device for removing interference signal of the first signal to obtain isolated first signal;
process, by the second processing module, the isolated first signal to obtain first specific multimedia signal; and
transmit, by the second transceiver module, the first specific multimedia signal to the display configured to display the first specific multimedia signal.
